(19) United States
(12) Patent Application Publication
(10) Pub. No.: US 2018/0153108 A1
(43) Pub. Date: Jun. 7, 2018

(54) Plant Transportation Assembly

(71) Applicant: Robert Villeneuve, Merrickville (CA)

(72) Inventor: Robert Villeneuve, Merrickville (CA)

(21) Appl. No.: 15/367,339

(22) Filed: Dec. 2, 2016

(51) Int. Cl. A01G 9/12; A01G 9/02; A01G 27/00; A01G 1/00; A01G 7/06; A01G 13/00; A01C 23/02; A01C 15/00; A01G 17/04

(52) U.S. Cl. CPC A01G 9/128; A01G 9/02; A01G 27/005; A01G 1/001; A01G 17/04; A01G 13/00; A01C 23/023; A01C 15/00; A01G 7/06

(57) ABSTRACT

A plant transportation assembly for inhibiting a plant from being damaged when the plant is transported includes a support that may be positioned in a plant pot thereby facilitating the support to extend upwardly from the plant pot. A plurality of restraints is provided and each of the restraints is removably coupled to the support. Each of the restraints is removably attached to a plant in the plant pot thereby facilitating the support to retain the plant in an upright orientation in the plant pot when the plant pot is being transported.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to transportation devices and more particularly pertains to a new transportation device for inhibiting a plant from being damaged when the plant is transported.

### BRIEF SUMMARY OF THE INVENTION

An embodiment of the disclosure meets the needs presented above by generally comprising a support that may be positioned in a plant pot thereby facilitating the support to extend upwardly from the plant pot. A plurality of restraints is provided and each of the restraints is removably coupled to the support. Each of the restraints is removably attached to a plant in the plant pot thereby facilitating the support to retain the plant in an upright orientation in the plant pot when the plant pot is being transported.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a plant transportation assembly according to an embodiment of the disclosure.

FIG. 2 is a perspective view of support of an embodiment of the disclosure.

FIG. 3 is a perspective view of a tube of an embodiment of the disclosure.

FIG. 4 is a perspective in-use view of an embodiment of the disclosure.

FIG. 5 is a perspective cut-away view of a tube of an embodiment of the disclosure.

### DETAILED DESCRIPTION OF THE INVENTION

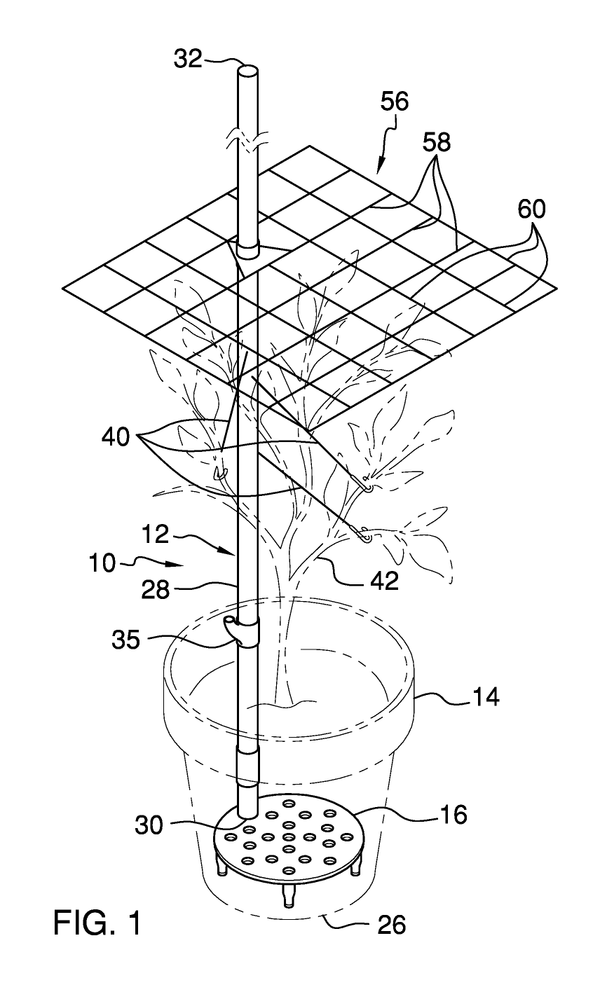

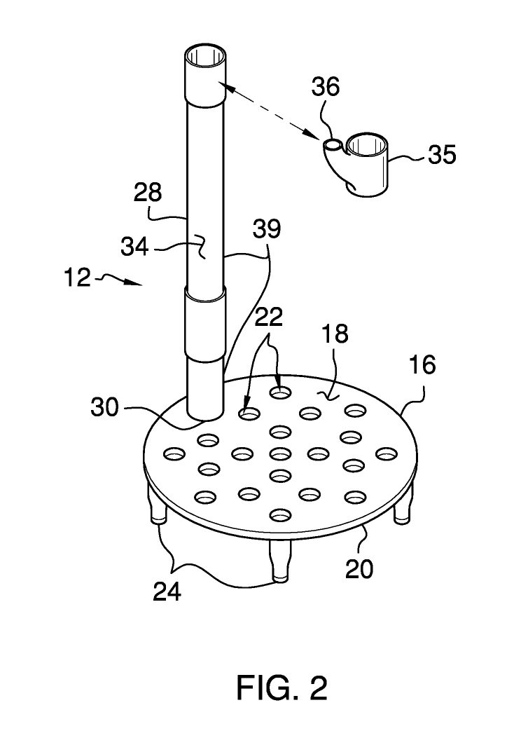

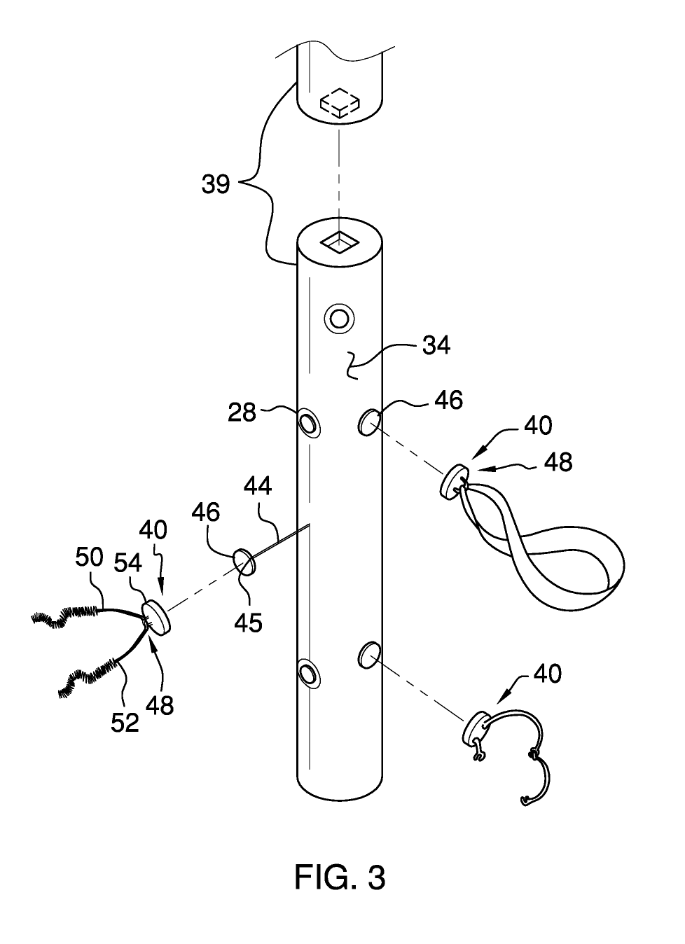

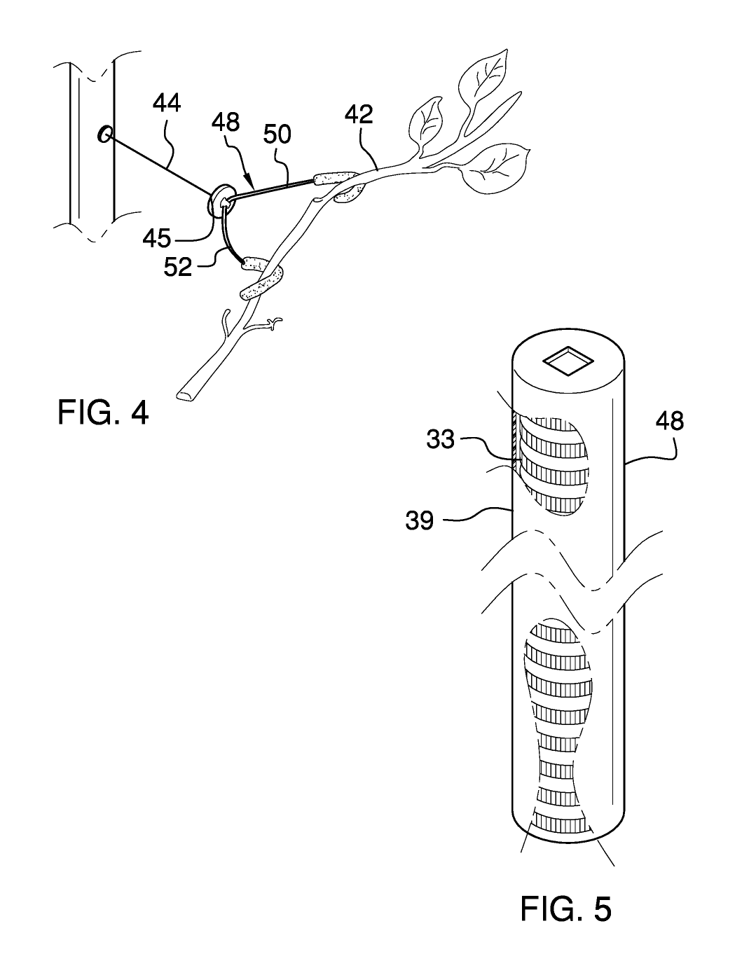

With reference now to the drawings, and in particular to FIGS. 1 through 5 thereof, a new transportation device embodying the principles and concepts of an embodiment of the disclosure and generally designated by the reference numeral 10 will be described.

As best illustrated in FIGS. 1 through 5, the plant transportation assembly 10 generally comprises a support 12. The support 12 may be positioned in a plant pot 14 thereby facilitating the support 12 to extend upwardly from the plant pot 14. The plant pot 14 may be a plant pot 14 of any conventional design.

The support 12 comprises a disk 16 that has a top surface 18 and a bottom surface 20. The disk 16 has a plurality of holes 22 extending through the top surface 18 and the bottom surface 20. The holes 22 are spaced apart from each other and are distributed on the disk 16. A plurality of legs 24 is provided and each of the legs 24 is coupled to and extends away from the bottom surface 20. Each of the legs 24 abuts a bottom wall 26 of the plant pot 14 thereby facilitating the disk 16 to be spaced from the bottom wall 26. The legs 24 are spaced apart from each other and are distributed on the disk 16.

A tube 28 is provided that has a first end 30, a second end 32 and an outer surface 34 extending therebetween. The first end 30 is coupled to the top surface 18 of the disk 16 and the tube 28 is offset from a center of the disk 16. The first end 30 is open and the tube 28 may contain a fertilizer 33 thereby facilitating the fertilizer 33 to be selectively released into the plant pot 14. The fertilizer 33 may be a granular fertilizer, a liquid 38 fertilizer or a solid fertilizer.

A spout 35 is coupled around the tube 28 such that the spout 35 is in fluid communication with an interior of the tube 28. The spout 35 has a distal end 36 with respect to the tube 28. The distal end 36 is open to facilitate a liquid to be poured into the tube 28. In this way the liquid is selectively released into the plant pot 14. The liquid may be water, fluid plant nutrients or other liquid 38 commonly used on the care of plants. The tube 28 may comprise a plurality of sections 39 and each of the sections 39 may be removably coupled together. In this way the tube 28 may be assembled to have a selected height.

A plurality of restraints 40 is provided and each of the restraints 40 is removably coupled to the support 12. Each of the restraints 40 is removably attached to a plant 42 in the plant pot 14 thereby facilitating the support 12 to retain the plant 42 in an upright orientation in the plant pot 14 when the plant pot 14 is transported. The restraints 40 are spaced apart from each other and are distributed on the support 12.

Each of the restraints 40 comprises a lanyard 44 that is coupled to the outer surface 34 of the tube 28 and the lanyard 44 has a distal end 45 with respect to the tube 28. The lanyard 44 may have a length ranging between approximately 15.0 cm and 30.0 cm. A first mating member 46 is coupled to the distal end 45 and the first mating member 46 may comprise a magnet or the like. The first mating member 46 corresponding to selected ones of the restraints 40 may be coupled to the outer surface 34 of the tube 28.

A holder 48 is provided and the holder 48 has a first member 50 and a second member 52. The holder 48 is comprised of a resiliently bendable material. Thus, each of the first member 50 and the second member 52 are manipulated to engage the plant 42. Each of the first 50 and second 52 members may be a bendable wire or the like. The first member 46 may comprise a clasp and the second member 52 may comprise a hoop that releasably engages the clasp. Additionally, each of the first 50 and second 52 members may be joined together to form a closed loop and the closed loop may be positioned around the plant 42.

A second mating member 54 is provided and the second mating member 54 is coupled to the holder 48. Each of the first member 50 and the second member 52 extends away from the second mating member 54. The second mating member 54 removably engages the first mating member 46. In this way the holder 48 is removably coupled to the lanyard 44 to restrain the plant 42. The second mating member 54 may comprise a magnet or the like and the second mating member 54 may magnetically engage the first mating member 46.

A frame 56 is provided and the frame 56 is selectively coupled to the tube 28. The frame 56 includes a plurality of first arms 58 each being coupled to and intersecting a plurality of second arms 60. Each of the first arms 58 and the second arms 60 are oriented to form a grid. The frame 56 is spaced from the plant pot 14 when the frame 56 is coupled to the tube 28. Thus, vines from the plant 42 may engage the frame 56 to restrain the plant 42.

In use, the support 12 is positioned in the plant pot 14 and both soil and the plant 42 are placed in the plant pot 14. A selected number of the restraints 40 are coupled to the tube 28 and each of the restraints 40 is attached to the plant 42. In this way each of the restraints 40 retains the plant 42 in an upright orientation in the plant pot 14. The fertilizer 33 in the tube 28 leaches into the soil thereby facilitating the plant 42 to absorb the fertilizer 33. The liquid 38 is selectively poured through the spout 35.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A plant transportation assembly being configured to restrain a plant when the plant is being transported, said assembly comprising:
a support being configured to be positioned in a plant pot thereby facilitating said support to extend upwardly from the plant pot; and
a plurality of restraints, each of said restraints being removably coupled to said support, each of said restraints being configured to be removably attached to a plant in the plant pot thereby facilitating said support to retain the plant in an upright orientation in the plant pot when the plant pot is being transported, said restraints being spaced apart from each other and being distributed on said support.

2. The assembly according to claim 1, wherein said support comprises a disk having a top surface and a bottom surface, said disk having a plurality of holes extending through said top surface and said bottom surface, said holes being spaced apart from each other and being distributed on said disk.

3. The assembly according to claim 2, further comprising a plurality of legs, each of said legs being coupled to and extending away from said bottom surface wherein each of said legs is configured to abut a bottom wall of the plant pot thereby facilitating said disk to be spaced from the bottom wall, said legs being spaced apart from each other and being distributed on said disk.

4. The assembly according to claim 2, further comprising a tube having a first end, a second end and an outer surface extending therebetween, said first end being coupled to said top surface of said disk, said tube being offset from a center of said disk, said first end being open, said tube being configured to contain a fertilizer thereby facilitating the fertilizer to be selectively released into the plant pot.

5. The assembly according to claim 4, further comprising a spout being coupled around said tube such that said spout is in fluid communication with an interior of said tube, said spout having a distal end with respect to said tube, said distal end being open wherein said distal end is configured to facilitate a liquid to be poured into said tube thereby facilitating the liquid to be selectively released into the plant pot.

6. The assembly according to claim 1, wherein:
said support includes a tube having an outer surface; and
each of said restraints comprises a lanyard being coupled to said outer surface of said tube, said lanyard having a distal end with respect to said tube.

7. The assembly according to claim 6, further comprising a first mating member being coupled to said distal end.

8. The assembly according to claim 7, further comprising a holder having a first member and a second member, said holder being comprised of a resiliently bendable material wherein each of said first member and said second member is configured to be manipulated to engage the plant.

9. The assembly according to claim 8, further comprising a second mating member being coupled to said holder having each of said first member and said second member extending away from said second mating member, said second mating member removably engaging said first mating member such that said holder is removably coupled to said lanyard wherein said holder is configured to restrain the plant.

10. A plant transportation assembly being configured to restrain a plant when the plant is being transported, said assembly comprising:
a support being configured to be positioned in a plant pot thereby facilitating said support to extend upwardly from the plant pot, said support comprising:
a disk having a top surface and a bottom surface, said disk having a plurality of holes extending through said top surface and said bottom surface, said holes being spaced apart from each other and being distributed on said disk,
a plurality of legs, each of said legs being coupled to and extending away from said bottom surface wherein each of said legs is configured to abut a bottom wall of the plant pot thereby facilitating said disk to be spaced from the bottom wall, said legs being spaced apart from each other and being distributed on said disk,
a tube having a first end, a second end and an outer surface extending therebetween, said first end being coupled to said top surface of said disk, said tube being offset from a center of said disk, said first end being open, said tube being configured to contain a fertilizer thereby facilitating the fertilizer to be selectively released into the plant pot,
a spout being coupled around said tube such that said spout is in fluid communication with an interior of said tube, said spout having a distal end with respect to said tube, said distal end being open wherein said distal end is configured to facilitate a liquid to be poured into said tube thereby facilitating the liquid to be selectively released into the plant pot; and
a plurality of restraints, each of said restraints being removably coupled to said support, each of said restraints being configured to be removably attached to the plant thereby facilitating said support to retain the plant in an upright orientation in the plant pot when the plant pot is being transported, said restraints being spaced apart from each other and being distributed on said support, each of said restraints comprising:
a lanyard being coupled to said outer surface of said tube, said lanyard having a distal end with respect to said tube,
a first mating member being coupled to said distal end,
a holder having a first member and a second member, said holder being comprised of a resiliently bendable material wherein each of said first member and said second member is configured to be manipulated to engage the plant, and
a second mating member being coupled to said holder having each of said first member and said second member extending away from said second mating member, said second mating member removably engaging said first mating member such that said holder is removably coupled to said lanyard wherein said holder is configured to restrain the plant.
